(19) United States
(12) Patent Application Publication
(10) Pub. No.: US 2010/0072223 A1
(43) Pub. Date: Mar. 25, 2010

(54) HOLDER SYSTEM FOR BAG-IN-BOX

(76) Inventor: Patrick Bedin, Lozanne (FR)

Correspondence Address: CANTOR COLBURN, LLP, 20 Church Street, 22nd Floor, Hartford, CT, 06103, US

(21) Appl. No.: 12/530,496

(22) PCT Filed: Mar. 5, 2008
(86) PCT No.: PCT/FR2008/000290

§ 371 Date: Dec. 4, 2009

(30) Foreign Application Priority Data
Mar. 9, 2007 (FR) 07/01735

(51) Int. Cl. B65D 35/56; B67D 7/06

(52) U.S. Cl. 222/105; 222/185.1

(57) ABSTRACT

The invention relates to a holder system for vertically holding a bag-in-box (1), in order to raise the pouring spout (3) thereof. The system includes four rigid feet (5) each provided with an intermediate cleat, and an elastic strap (6). The feet (5) are applied against the side surface of the bag-in-box (1) at the angles thereof, wherein the cleats are used as bearing points for the bottom (4) of the bag-in-box. The elastic strap (6) surrounds and clamps the bag-in-box (1) and the feet (5) applied against the side surface thereof. The invention can be used for bag-in-boxes for wine or other beverages of any format and capacity.

### TECHNICAL FIELD OF THE INVENTION

The present invention relates to the use and particularly the holding of packages for liquid products, in particular in the food field for drinks and also more particularly for wine, the packages considered in this instance to be designated as “wineskin boxes” and also being known under the commercial designations of “bag-in-box” or “cubitainer”.

### BRIEF DESCRIPTION OF RELATED ART

It is a well known practice to package wine, and if necessary other drinks, in such a package which comprises a cardboard box, usually of parallelepipedal shape, and a flexible wineskin placed in the box. The wineskin is fitted with a pouring tap, which protrudes on the outside of the box, on one of the side faces of this box at a low height above the bottom of the latter.

In order to be able to draw off the liquid content of such a package, it is necessary to place it at a height, in particular so as to have beneath the pouring tap a sufficient space in order to offer up a receptacle, such as a glass, designed to collect the liquid for the purpose of consuming it.

A solution already proposed for placing the pouring tap at a sufficient height, for the purpose of using the bag-in-box, consists in extending downward the side faces of the box, thereby heightening the bottom of this box—see French patent application FR2798912 in the name of the applicant. This solution however requires a special manufacture of the bag-in-box requiring a considerable additional quantity of cardboard in order to extend downward the side faces of the box. In addition, such a solution greatly increases the space requirement (in height) of the package, while creating an unused volume beneath the raised bottom of the box.

Another type of solution, partly avoiding these drawbacks, consists in creating and using a holder forming a kind of base, on which the package will be placed, the latter then not requiring any special manufacture. The package is therefore placed at a sufficient height for a receptacle, such as a glass, to be offered up easily beneath its pouring tap. Examples of heightening holders for bag-in-boxes are provided by French patent application FR2797937 in the name of the applicant, or by the British patent application GB2148705, or else by the international patent application WO95/17841.

Such holders are themselves bulky, in particular if they are not made to be foldable or removable. They may, in addition, be unattractive and/or may mask the package that they hold. In the case of removable holders, the system of assembly may be complex and difficult for the user to set up. Finally, each holder proposed hitherto is suitable for a single format of bag-in-box, while there are currently such packages with several clearly distinct standard capacities (3, 5 and 10 liters).

### BRIEF SUMMARY OF THE INVENTION

The invention removes the latter drawbacks, by providing a holding system of a new design for the packages of the kind considered here, the proposed solution being simple, requiring little space and being attractive, and above all being adaptable without adjustments to all bag-in-box formats.

Accordingly, the subject of the invention is a holder assembly for a bag-in-box, designed for vertically holding a bag-in-box so as to heighten the pouring tap of the latter, the assembly essentially consisting of four rigid feet each furnished with an angle wedge placed at intermediate height, and of at least one elastic strap, the feet being designed to be pressed against the side surface of the bag-in-box, in particular at the corners of the latter, and the angle wedges being capable of serving as resting points for the bottom of the bag-in-box, while the elastic strap is designed to surround and clamp the bag-in-box and the feet pressed against the side surface of this bag-in-box.

The four feet of this holder assembly advantageously have the shape of angle posts and the angle wedges are preferably in this case each formed of one facet perpendicular to the two wings of the angle post. The edge along which these two wings join together may comprise a slot or a notch which is used to position the elastic strap.

Therefore, the holder assembly according to the invention comprises four separate feet which will in particular be placed respectively at the four vertical corners of the bag-in-box, and an elastic strap which, placed around the bag-in-box and the four feet thus positioned, will keep these feet clamped against the bag-in-box, the latter also resting on the angle wedges of the various feet.

Such a device has many advantages:
The holder assembly is particularly simple since the four feet are all identical parts that can, for example, be obtained by molding, and this assembly requires no additional assembly system or accessory.
When it is not in use, for example for its storage or its initial delivery, the holder assembly occupies a very small space, the four feet having an elongated shape, while the strap occupies a negligible volume.
The independence of the four feet combined with the elasticity of the strap makes it possible to use the same device with bag-in-boxes of any format and of any capacity, by adapting it directly and instantaneously. Moreover, the larger the bag-in-box, the more stretched will be the strap and the more it will clamp the feet against the corners of the bag-in-box, which makes the device particularly effective.
In the position of use, the holder assembly is particularly attractive and discrete: the feet being pressed against the corners of the bag-in-box are not very visible and do not mask the side faces of this bag-in-box, thereby allowing any markings they may have to be easily readable; a possible production of the feet in a transparent material may even leave the side faces of the bag-in-box totally visible. In addition, the spacing of the feet leaves a “natural” free passageway for the pouring tap.
The holder assembly is put together simply, without accessories and without tools, and also with no risk of error and even with a certain aspect of fun.
Once put in place, the four feet also provide reinforcement and protection for the vertical corner zones of the bag-in-box.
Thanks to the tightness of the strap, the holder assembly is firmly secured to the bag-in-box; the whole unit may therefore be moved easily and without risk, for example by lifting the bag-in-box.
Shoes advantageously placed at the ends of the feet prevent noise and scratching, particularly if the assembly is moved or placed on any surface. Moreover, these shoes have an anti-slip function.
A simple heightening of the two “rear” feet, relative to the two “front” feet, makes it possible to tilt the bag-in-box in order to facilitate and optimize its emptying, in particular when it contains only a small quantity of liquid.
The assembly forms a robust and stable holder, which is practically impossible to wear out and can be re-used infinitely.
This holder assembly, in particular its feet, can be made economically and in all materials and styles:

metal, synthetic resin, wood, etc., with varied shapes and possible decorations.

### BRIEF DESCRIPTION OF THE DRAWINGS

In any case, the invention will be better understood with the aid of the following description, with reference to the appended schematic drawing representing, as an example, one embodiment of this holder assembly for a bag-in-box:

FIG. 1 is a view in perspective of a holder assembly according to the present invention, placed around a bag-in-box of relatively large capacity;

FIG. 2 is a view in perspective of the same holder assembly, used with a bag-in-box of smaller capacity;

FIG. 3 is a front view, corresponding to the configuration of FIG. 1;

FIG. 4 is a side view, corresponding also to the configuration of FIG. 1;

FIG. 5 is a representation of a single foot belonging to this holder assembly, seen from the outside;

FIG. 6 is a representation of the foot of FIG. 5 seen from the inside.

### DETAILED DESCRIPTION OF THE INVENTION

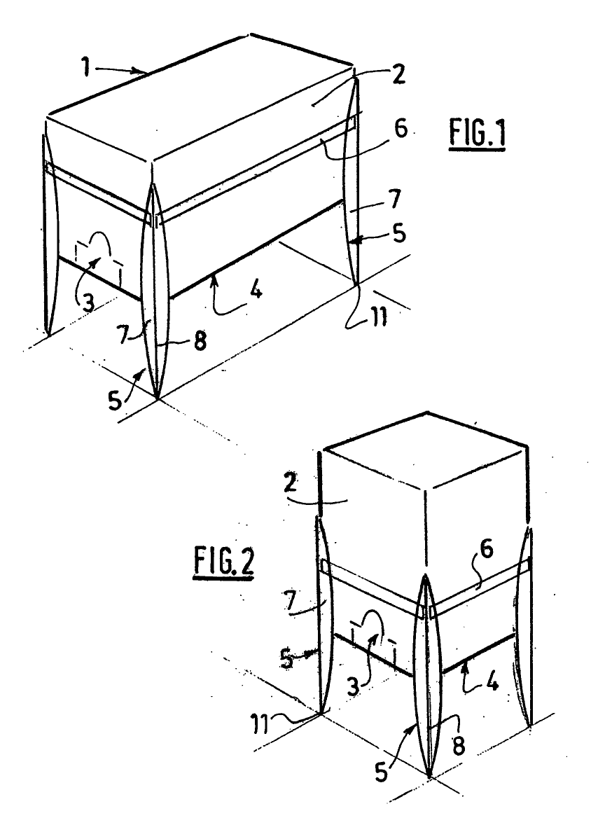

FIGS. 1 to 4 show a bag-in-box designated in its entirety by the reference number 1, showing the parallelepipedal cardboard box 2 and the pouring tap 3 which protrudes on the outside on one of the side faces, at a relatively low height above the bottom 4 of the box 2.

In the case of FIGS. 1, 3 and 4, it is a bag-in-box 1 of relatively large capacity, for example ten liters, which is used in a substantially horizontal position. Conversely, in the case of FIG. 2, it is a bag-in-box 1 of relatively small capacity, for example three or five liters, which is used in a substantially vertical position.

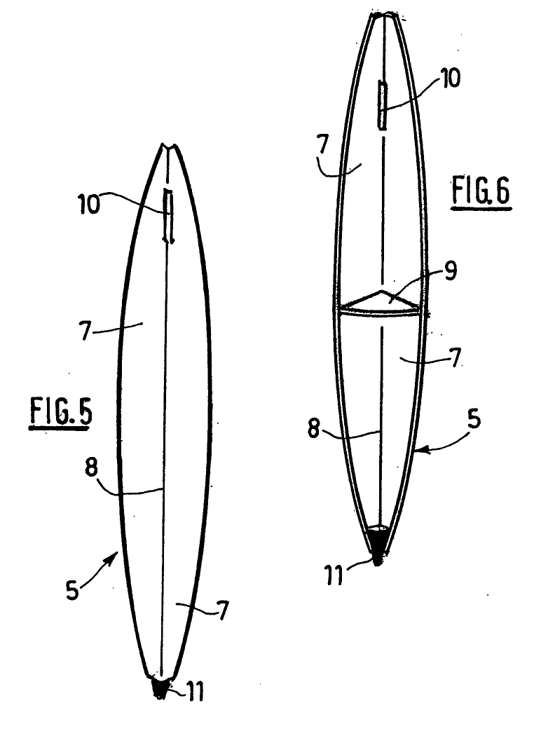

The holder assembly provided for one or other of these bag-in-boxes 1 is the same and comprises four identical feet 5, supplemented by an elastic strap 6, the configuration of a foot 5 being in particular illustrated by FIGS. 5 and 6.

Each foot 5 has the shape of an angle post, with two wings 7 placed at right angles and joining together along an edge 8. In the central region of the foot 5, an angle wedge 9 is provided, in the shape of a facet perpendicular to the two wings 7 of the angle post and being connected to these two wings 7. The whole of the foot 5, with its angle wedge 9, can be made in a single piece particularly by molding synthetic resin.

Each foot 5 also comprises, optionally, a slot or notch 10 arranged in its upper region on the edge 8, and a shoe 11 made of damping material placed at its bottom end (with reference to the vertical position of use of the foot 5).

In the position of use, as shown in FIGS. 1 to 4, the four feet 5 are pressed against the side surface of the box 2 of the bag-in-box 1, respectively at the four corners of this side surface, the rectangular bottom 4 of the box 2 then being able to rest, in the zones of its four corners, on the respective angle wedges 9 of the four feet 5. The elastic strap 6 is put in place horizontally around the bag-in-box 1 and the four feet 5, and it thus presses these four feet 5 against the side surface of the box 2 of the bag-in-box 1. The elastic strap 6 is positioned high up in the slots or notches 10 of the feet 5, if the latter are provided.

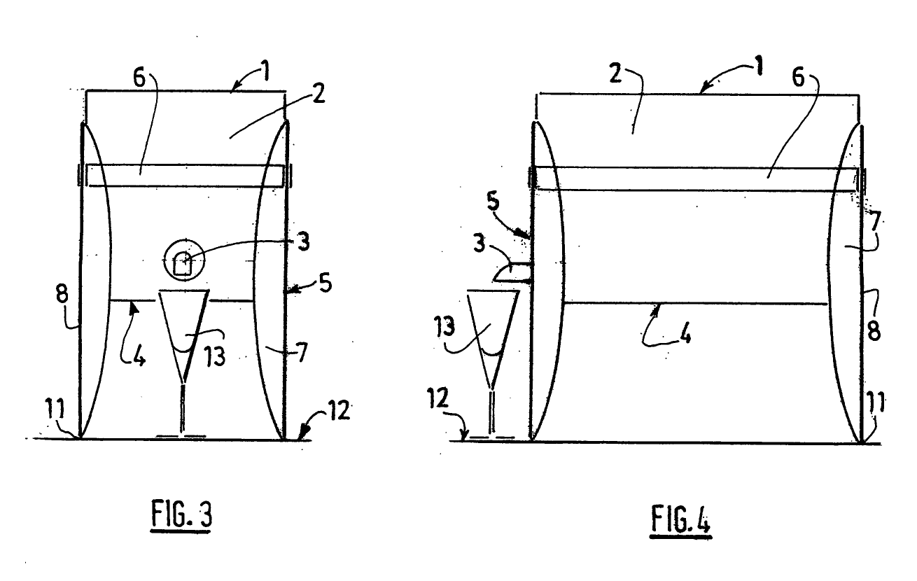

Therefore, the holder assembly consists, for the bag-in-box 1, of a base which can rest on a horizontal surface 12 via the shoes 11 of the four feet 5, and which holds the bag-in-box 1 high. In particular, the pouring tap 3 is then at a height above the surface 12 so that it leaves, beneath it, a free space that is sufficient to offer up a receptacle, such as a glass 13, designed to collect the drink poured by the tap, so that it can be consumed (see FIGS. 3 and 4).

As results from comparing FIGS. 1 and 2, the same holder assembly according to the invention can be adapted, with no transformation, to bag-in-boxes 1 of capacities and even of shapes that are extremely variable. In this respect, note that this holder assembly could also perfectly be used with a bag-in-box with a shape that is not parallelepipedal but prismatic, that is to say with a side surface having a number of sides other than four, and even with a cylindrical-shaped bag-in-box.

If necessary, by placing the angle wedges 9 in a position that is not central on the feet 5, the user has (by inverting the direction of assembly of these feet) the choice of two different heights for raising the bag-in-box 1 relative to the horizontal surface 12.

By the same principle, it is also possible to heighten the pair of “rear” feet 5 relative to the pair of “front” feet 5, if necessary dispensing with resting the box 2 on certain angle wedges 9, in order to hold the bag-in-box 1 in a position that is slightly inclined relative to the horizontal, in order to make the bag-in-box 1 easier to empty completely, particularly when the quantity of drink remaining becomes small.

As it goes without saying, and as emerges from the foregoing, the invention is not limited solely to the embodiment of this holder assembly for a bag-in-box that has been described above, as an example; on the contrary, it embraces all the variants of embodiment and of application complying with the same principle. In this way, in particular, a person skilled in the art would not be departing from the context of the invention:
by producing the feet with other shapes in detail and with a different appearance, or in different materials, for example based on metal wire;
by providing not a single elastic strap, but two or more such straps, superposed, all encircling the same bag-in-box;
by designing this holder assembly for bag-in-boxes that can contain all kinds of drinks, or even other liquid products.

1. A holder assembly for a bag-in box, designed for vertically holding a bag-in-box so as to heighten the pouring tap of the latter, comprising four rigid feet each furnished with an angle wedge placed at intermediate height, and at least one elastic strap, the feet being designed to be pressed against a side surface of the bag-in-box, in particular at corners of the latter, and the angle wedges being capable of serving as resting points for a bottom of the bag-in-box, while the elastic strap is designed to surround and clamp the bag-in-box and the feet pressed against the side surface of the bag-in-box.

2. The holder assembly as claimed in claim 1, wherein the four feet have a shape of angle posts, the angle wedges preferably each being formed of one facet perpendicular to two wings of the angle post.

3. The holder assembly as claimed in claim 2, wherein an edge along which the two wings join together comprises a slot or a notch which is used to position the elastic strap.

4. The holder assembly as claimed in claim 1, wherein shoes are placed at ends of the feet.
